(19) United States
(12) Patent Application Publication
(10) Pub. No.: US 2001/0028198 A1
(43) Pub. Date: Oct. 11, 2001

(54) Circuit for stabilizing an ac power line

(76) Inventor: Reinhard E. Joho, Rombach (CH)

Correspondence Address: Reinhard Joho, Rombachtaeli 21, CH-5022 Rombach, CH

(21) Appl. No.: 09/846,550

(22) Filed: Apr. 27, 2001

Related U.S. Application Data
(63) Continuation-in-part of application No. 09/284,346, filed on Apr. 15, 1999, now abandoned.
(63) Continuation of application No. PCT/EP98/05298, filed on Aug. 20, 1998.

(51) Int. Cl. H02H 1/00

(52) U.S. Cl. 307/125

(57) ABSTRACT

The circuit consists of an oscillatory circuit (1) and a link switching element (2). The oscillatory circuit consists of a precharged capacitance (3), an inductance (4) and an switching element (5). When activated the oscillatory circuit generates positive and negative current half-cycles, each one triggered in synchronism to the line (P₁, P₂). Capacitance and inductance are dimensioned such that the period of the generated current half-cycles is less or equal the half-cycle period of the line. The oscillating voltage across the capacitance is connected to the line by the link element. The stabilizing current characteristics can be varied over a wide range.

### TECHNICAL FIELD

The invention relates to a circuit for stabilizing an ac power line. One or several of these circuits are connected in parallel to the line. The circuit is activated if one or more line parameters, especially the line voltage, have left or will predictably leave preset tolerance ranges. This is for example the case when loads with inrush currents are connected to the line, while clearing short circuits in the line by circuit breakers or fuses, or during malfunctionning of power transmission devices. Weak lines are especially endangered. These kind of lines are for example lines involving long interconnections, or converter-fed lines, where in case of overload the converter disconnects automatically from the line.

### BACKGROUND ART

Devices for dynamically stabilizing ac power lines are known. As an example, rotating var-compensators are acting this way. In case of sudden change of the line parameters these are capable of exchanging large quantities of real and reactive power with the line and thereby compensating the disturbance. The disadvantage of rotating var-compensators lies in the large investment and maintenance costs, also their permanent losses are not neglectable. Static var-compensators, consisting of a capacitance and a parallel phase-controlled inductance, have too little stored energy for the given task and in addition inject harmonic currents in the line. U.S. Pat. No. 4,047,097 describes a procedure for connecting a static var-compensator to the line. This is done by precharging the capacitance and switching it to the inductance such that the generated oscillating voltage is in-phase to line voltage. The procedure serves for a soft-switching of the static var-compensator to the line. Also known is converter-fed line-stabilization by switched, or for lower power linear controlled, semiconductor arrangements which for example are supplied by a capacitively supported voltage source. As a disadvantage, their design for the required dynamic stabilizing power, which can go up to 30 times rated line power, would be extremely expensive. Moreover, switched semiconductor arrangements produce harmonics.

### DISCLOSURE OF INVENTION

In the view of the foregoing it is the object of the invention to find a simple and robust circuit which is primarily used for dynamic line stabilization. The circuit according to the present invention consists of an oscillatory circuit and a link switching element. Current half-cycles are generated in the oscillatory circuit by a dc-precharged capacitance, an oscillatory inductance and a switching element. Each current half-cycle is individually triggered in synchronism to the line. Capacitance and inductance are thus dimensioned that the period of the current half-cycles is less than or equal to the line half-cycle period, the oscillatory circuit is not mandatorily tuned to line frequency. Switching the line to this oscillatory circuit by the link switching element allows branching of stabilizing current to the line. In contrast to static var-compensators having reactive currents in the range of rated line current, the current in the capacitance and inductance of the oscillatory circuit is at least in the range of line short-circuit current. The oscillating elements each have a stored energy of at least an order of magnitude higher than comparable elements of static var-compensators. The coupling to the oscillatory circuit may be galvanically to the capacitance or inductively to the oscillatory inductance. Triggering of the current half-cycles is done such that the voltage of the capacity is approximately in-phase to the line voltage. The link switching element can be built-up in bridge connection.

The circuit according to the invention has the advantage of a similar behaviour as a rotating var-compensator. Stabilizing initial current and decay can be set over a wide range. The circuit can also be used for damping of harmonics and oscillations in the line. The circuit is of simple and robust design, there are no standby losses and while activated the circuit produces small harmonics. It can be used for lines in the range of some few kVA up to some thousand MVA. It profits from the steady development of capacitors towards more capacitance per volume.

### BRIEF DESCRIPTION OF DRAWINGS

FIG. 1 shows the basic stabilizing circuit of the invention.

FIG. 2 shows an embodiment of the switching elements of the circuit.

FIG. 3 shows the principal electrical operation of the circuit.

FIG. 4 shows an embodiment of the circuit comprising galvanic coupling to the capacitance.

FIG. 5 shows an embodiment of the circuit comprising inductive coupling to the oscillatory inductance.

FIG. 6 shows the connection to the line using a bridge connection in the link switching element.

FIG. 7 shows the connection to a three-phase line using a bridge connection.

FIG. 8 shows three circuits connected in delta to a three-phase line.

FIG. 9 shows an embodiment of the capacitance by using polarized capacitors.

FIG. 10 shows the use of elements of a pwm-converter for the circuit according to the invention.

### DETAILED DESCRIPTION AND PREFERRED EMBODIMENTS

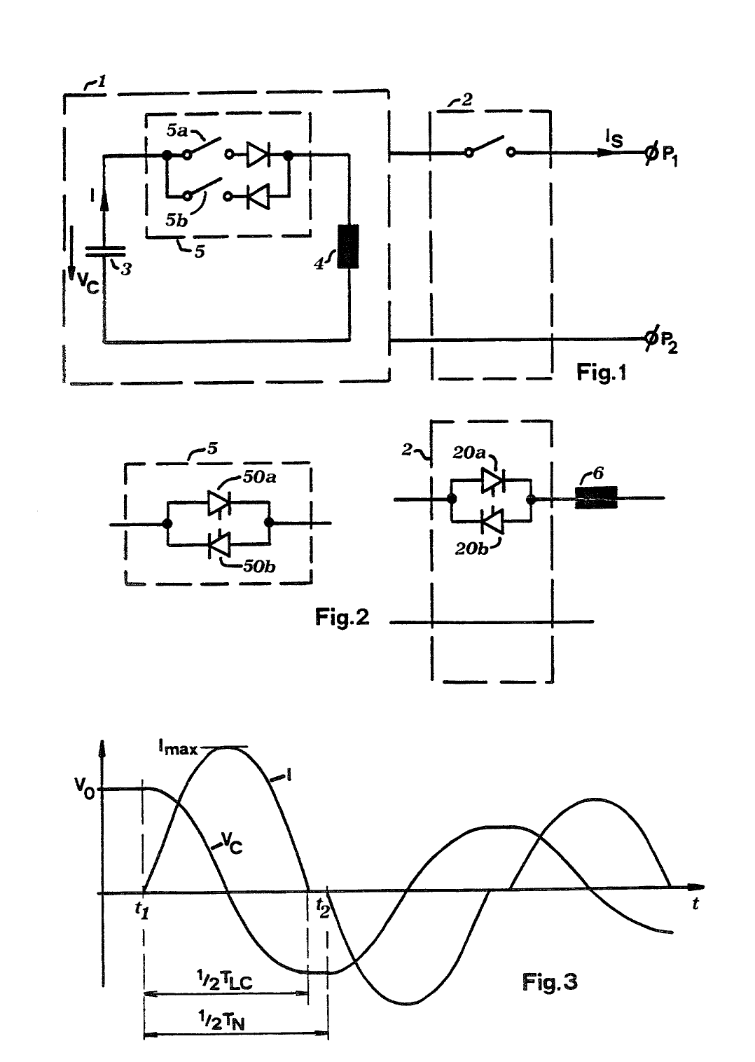

FIG. 1 shows the basic circuit of the invention. The circuit consists of an oscillatory circuit 1 and a coupling of the line P₁, P₂ to the oscillatory circuit by means of the link switching element 2. The oscillatory circuit 1 consists of the capacitance 3, the oscillatory inductance 4 and the switching element 5. The switching element consists of two parallel switching branches 5a, 5b, each being capable of conducting in one direction and which are connected with opposite polarization. The capacitance is held in precharged state in standby by a not shown charging device. All the elements of the oscillatory circuit are connected such that they form a closed current loop. In activated state the oscillatory circuit 1 generates current half-cycles. The switching branches 5a, 5b of the switching element 5 are triggered such that positive and negative current half-cycles are generated in synchronism to the line. By galvanic or inductive coupling of the line to the oscillatory circuit 1 stabilizing current is fed to the line via the link switching element 2. In activated state of the circuit the link switching element can be switched in synchronism to the line, if needed phase-controlled, but preferably it remains closed in both polarities while the circuit is being activated.

A simple embodiment of the switching element 5 is shown in FIG. 2. This consists of two thyristors 50a, 50b connected in anti-parallel. The switch of the link switching element 2 can also consist of two anti-parallel thyristors 20a, 20b. For further widening the range of dimensioning a link inductance 6 can be inserted in the link to the line.

The principal electrical operation is shown in FIG. 3. The capacitance 1 is kept at a charging voltage V₀. This corresponds at least to the crest value of the rated line voltage. Activating of the circuit is started by closing one of the switching branches, for example 5a, at the time t₁, whereby the capacitance 3 starts a half-cycle swing with the oscillatory inductance 4 and the not shown line inductance. This half-cycle swing produces a half-cycle current I in the capacitance. The ratio of the inductances and the development of the disturbed line then determine the stabilizing current Iₛ into the line. Preferentially the oscillatory inductance is in the range of 25 . . . 100% of the sum of link inductance and line inductance. Because currents are relating in inverse manner to reactances this results in currents in the oscillatory circuit being in the range of 1 to 4 times of line short-circuit current. Generally the line short-circuit reactance is in the range of 3 to 10% of the rated line impedance. Thus the current in the oscillatory circuit is 10 to 120 times of that in a static var-compensator. This results in the oscillating elements having a stored energy or a reactive power of at least an order of magnitude higher than comparable elements of static var-compensators. The oscillatory circuit impresses its stiff oscillating voltage into the line and is hardly detuned by the line inductance. This allows a continuation of oscillating mode after connecting the circuit to line. At the end of the half-cycle swing the chosen switching branch 5a opens automatically or by being actively switched off. By dimensioning of capacitance and inductances and taking into account the line inductance the period T_{LC} of the oscillation is kept less or equal the period T_{N} of the line.

Therefore:

T_{N}≧T_{LC}=2π\sqrt{LC}

where

T_{LC} period of oscillation

T_{N} period of line

C capacitance

L composition of oscillatory-, link- and line-inductance and:

Iₘₐₓ≈V₀/\sqrt{L/C}

where

Iₘₐₓ maximum oscillatory current in first half-cycle

V₀ dc charging-voltage of capacitance

It is essential that the circuit consisting of capacitance 3, oscillatory inductance 4, link inductance 6 and line inductance must not be tuned to line frequency. At the time t₁+half line period the anti-parallel switching branch, for example 5b is closed, whereby the inverse polarized half-cycle is produced, and so on. The decay of the generated stabilizing current is determined by the losses of the circuit and the supply of real power into the line. The activated oscillatory circuit is switched such that the capacitance voltage is approximately in-phase with the line voltage. The triggering pulses for the switching branches 5a, 5b can be produced by an auxiliary circuit, generating an ideal line-voltage image. Such an image is realised in known circuits by use of phase-locked loop devices.

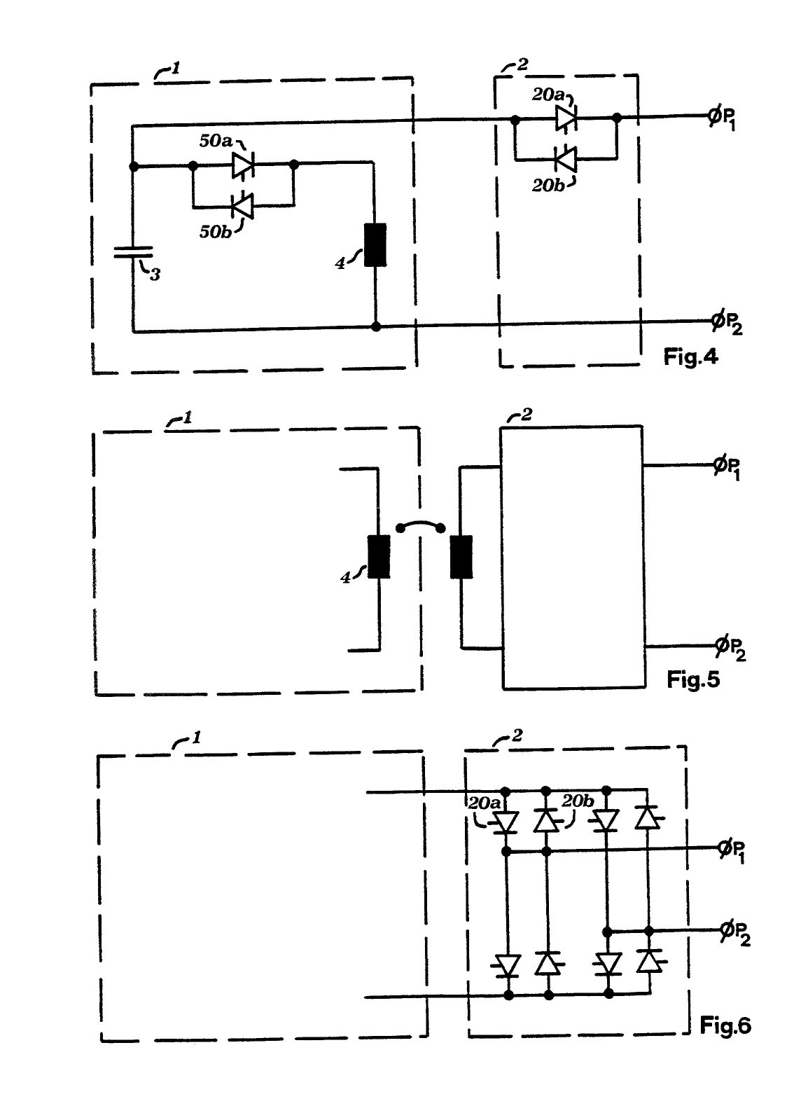

FIG. 4 shows the embodiment of the circuit with galvanic coupling of the line to the capacitance 3. FIG. 5 shows an inductive coupling of the line to the oscillatory circuit. This is done by coupling to the oscillatory inductance 4 which is used as part of a transformer or autotransformer. The charging voltage of the capacitance 3 has to be adapted to the turns ratio.

Because the capacitance 3 is precharged with a fixed polarity a period of up to 360° can elapse from starting of disturbance until first switching of the circuit. By using a bridge connection in the link switching element 2 as shown in FIG. 6, the maximum delay can be reduced to 180°. The branches of the bridge consist of the above mentionned switching branches, represented here by thyristor pairs 20a, 20b. During an activation of the circuit two diagonally arranged branches of the bridge stay closed.

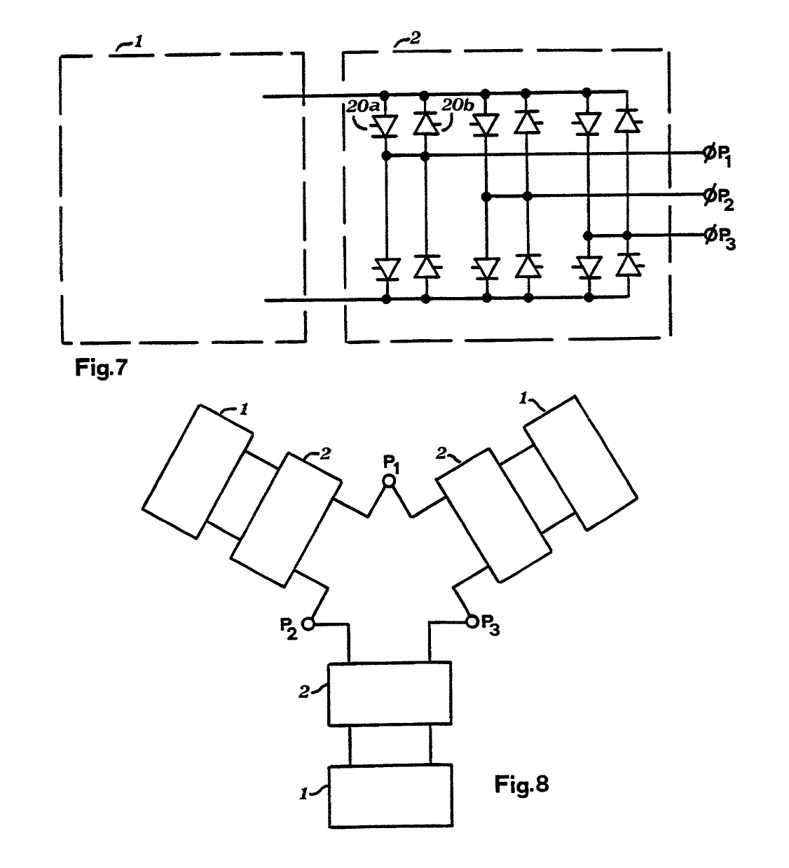

FIG. 7 shows the embodiment of the link switching element 2 as three-phase bridge for the connection to a three-phase line P₁, P₂, P₃. Thereby one circuit can selectively stabilize one of the three phases.

For a simultaneous stabilizing of all three phases of a three phase line an arrangement of three circuits according to FIG. 8 is needed. An arrangement in delta is shown, an arrangement in wye is also possible whereby the neutral line conductor can be involved.

The width of the generated current half-cycles can be self-adapted during operation by means of tappings in the inductances, thereby achieving half-cycles as wide as possible.

The activating of the circuit can be triggered by the decay of the grid voltage beyond a preset value, preferentially combined with a minimum timing threshold. It is also possible to start triggering if the value of the difference between line voltage and ideal line-voltage image exceeds a preset value, preferentially combined with a minimum timing threshold.

As an alternative use, the circuit can be activated before an expected line disturbance. The circuit losses are then automatically supplied from the line. By proper dimensioning the circuit can be used in steady-state operation as harmonics filter and voltage-dip filter or, by slightly phase-shifting the triggering pulses to the line voltage, as low harmonics static var-compensator.

The circuit is disconnected from line by one or several of the following processes:

voltage of capacitance 3 decays beyond preset value

voltage of capacitance 3 increases

line voltage increases

current in the link to the line falls beyond preset value

real power supplied in the line becomes negative.

For highest ratings the switching elements 2, 5 are preferentially equipped with elements of the type silicon carbide (SiC). Selected components of the circuit may be kept in a superconducting state.

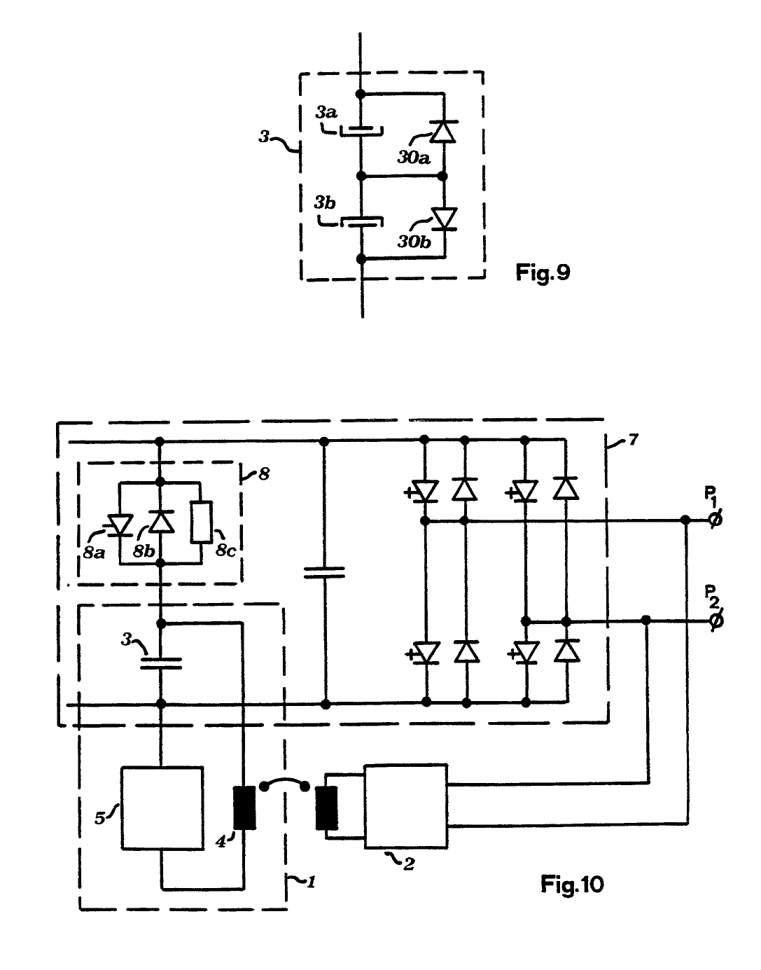

FIG. 9 shows the use of polarized capacitors as elements of the capacitance 3. The capacitance is composed of series-connected polarized capacitors 3a, 3b which are arranged in same amount in each polarity and which are protected in each polarity by at least one parallel diode 30a, 30b.

FIG. 10 shows the use of elements of a pwm-converter for the stabilizing circuit. In the shown example a part of the dc link capacitance is used as capacitance 3 of the circuit. A decoupling element 8 contains a thyristor or similar device 8a, a diode 8b and a resistor 8c. When detecting irregular line parameters the converter disconnects from the line, at the same time thyristor 8a is deactivated, which allows activating of the oscillatory circuit 1. The stabilizing current is produced by inductive coupling to the inductance 4 and feeding via the link switching [link] element 2 to the line connections of the converter P₁, P₂. This allows to use at least part of the dc-link energy for the injection of a stabilizing current in the disturbed line. The resistor 8c serves for voltage equilibration of the dc-link capacitors before reclosing the thyristor 8a.

1. Circuit for stabilizing the voltage of an ac power line, characterized by an oscillatory circuit (1) comprising a precharged capacitance (3), an oscillatory inductance (4) and a switching element (5), the oscillating current in said oscillatory circuit being at least in the range of line short-circuit current, said oscillatory circuit generating current half-cycles, each one triggered in synchronism to the line and said oscillatory circuit being connected to the line by a link switching element (2).

2. Circuit according to claim 1, characterized by a connection of the line to the capacitance (3) of the oscillatory circuit.

3. Circuit according to claim 1, characterized in that the connection to the line comprises a link inductance (6).

4. Circuit according to claim 1, characterized by a transformer or autotransformer connection of the line to the oscillatory inductance (4).

5. Circuit according to claim 1, characterized in that the capacitance (3) is precharged at least to a charging voltage corresponding to the crest voltage of the rated line voltage.

6. Circuit according to claim 1, characterized in that the width of the generated current half-cycles is less or equal half line period, as governed by the values of capacitance and inductances.

7. Circuit according to claim 6, characterized in that the width of the current half-cycles is automatically controlled in operation by using tapping in the inductances.

8. Circuit according to claim 1, characterized in that the switching elements (2, 5) are realized as thyristors connected in anti-parallel.

9. Circuit according to claim 1, characterized in that the link switching element (2) is composed in bridge-connection.

10. Circuit according to claim 1, characterized by three identical circuits being connected in delta or wye to a three-phase line.

11. Circuit according to claim 1, characterized by the generation of the triggering pulses for the switching element (5) in an ideal line-voltage image.

12. Circuit according to claim 1, characterized in that during the stabilizing period the switching element (5) is actuated by pulses such that the generated voltage half-cycles at the capacitance (3) are in-phase to the line-voltage and that the link switching element (2) is in closed state during the stabilizing period.

13. Circuit according to claim 1, characterized in that the circuit is activated by the decay of the line voltage beyond a preset value.

14. Circuit according to claim 1, characterized in that the circuit is activated if the value of the difference between line-voltage and ideal line-voltage image exceeds a preset value.

15. Circuit according to claim 1, characterized in that the disconnection from the line is actuated by one or more of the following processes:
capacitance voltage decays beyond preset value
capacitance voltage increasing
line voltage increases
current in link falls beyond preset value
real power supplied in the line becomes negative.

16. Circuit according to claim 1, characterized by at least parts of one or more circuits being elements of a pwm-converter (7), the output of said pwm-converter being connected to the line, when needed said elements being decoupled from the pwm-converter and said circuit further stabilizes the output of said pwm-converter.

17. Circuit for stabilizing the voltage of an ac power line, characterized by an oscillatory circuit (1) comprising a precharged capacitance (3), an oscillatory inductance (4) and a switching element (5), the oscillating elements having each a stored energy of at least an order of magnitude higher than comparable elements of known static var-compensators, said oscillatory circuit generating current half-cycles, each one triggered in synchronism to the line and said oscillatory circuit being connected to the line by a link switching element (2).

18. Circuit according to claim 17, characterized by a connection of the line to the capacitance (3) of the oscillatory circuit.

19. Circuit according to claim 17, characterized in that the connection to the line comprises a link inductance (6).

20. Circuit according to claim 17, characterized by a transformer or autotransformer connection of the line to the oscillatory inductance (4).

21. Circuit according to claim 17, characterized in that the capacitance (3) is precharged at least to a charging voltage corresponding to the crest voltage of the rated line voltage.

22. Circuit according to claim 17, characterized in that the width of the generated current half-cycles is less or equal half line period, as governed by the values of capacitance and inductances.

23. Circuit according to claim 22, characterized in that the width of the current half-cycles is automatically controlled in operation by using tapping in the inductances.

24. Circuit according to claim 17, characterized in that the switching elements (2, 5) are realized as thyristors connected in anti-parallel.

25. Circuit according to claim 17, characterized in that the link switching element (2) is composed in bridge-connection.

26. Circuit according to claim 17, characterized by three identical circuits being connected in delta or wye to a three-phase line.

27. Circuit according to claim 17, characterized by the generation of the triggering pulses for the switching element (5) in an ideal line-voltage image.

28. Circuit according to claim 17, characterized in that during the stabilizing period the switching element (5) is actuated by pulses such that the generated voltage half-cycles at the capacitance (3) are in-phase to the line-voltage and that the link switching element (2) is in closed state during the stabilizing period.

29. Circuit according to claim 17, characterized in that the circuit is activated by the decay of the line voltage beyond a preset value.

30. Circuit according to claim 17, characterized in that the circuit is activated if the value of the difference between line-voltage and ideal line-voltage image exceeds a preset value.

31. Circuit according to claim 17, characterized in that the disconnection from the line is actuated by one or more of the following processes:
capacitance voltage decays beyond preset value
capacitance voltage increasing
line voltage increases
current in link falls beyond preset value
real power supplied in the line becomes negative.

32. Circuit according to claim 17, characterized by at least parts of one or more circuits being elements of a pwm-converter (7), the output of said pwm-converter being connected to the line, when needed said elements being decoupled from the pwm-converter and said circuit further stabilizes the output of said pwm-converter.
